(19) United States
(12) Patent Application Publication
(10) Pub. No.: US 2011/0003211 A1
(43) Pub. Date: Jan. 6, 2011

(54) ELECTRODES WITH SOLID POLYMER ELECTROLYTES

(75) Inventors: William Hudson, Berkeley, CA (US); Hany Basam Eitouni, Oakland, CA (US); Mohit Singh, Berkeley, CA (US); Nitash Pervez Balsara, El Cerrito, CA (US); Ilan Gur, San Francisco, CA (US)

Correspondence Address: SEEO, INC., 626 BANCORFT WAY, SUITE 3B, BERKELEY, CA, 94710, US

(73) Assignee: Seeo, Inc., Berkeley, CA (US)

(21) Appl. No.: 12/867,665

(22) PCT Filed: Feb. 13, 2009
(86) PCT No.: PCT/US09/34156

§ 371 Date: Aug. 25, 2010

Related U.S. Application Data
(60) Provisional application No. 61/028,443, filed on Feb. 13, 2008.

(51) Int. Cl. H01M 10/26

(52) U.S. Cl. 429/304

(57) ABSTRACT

An electrode assembly that includes an electrode film and a current collector is provided. The electrode film includes electrode active material, electronically conductive particles, and a solid polymer electrolyte. In some embodiments, no additional binder is used as the solid polymer electrolyte also acts as a binder to hold together the active material and electronically conductive particles, thus creating a freestanding electrode film. Such a freestanding film makes it possible to deposit a very thin current collector layer, thus increasing specific energy and specific power for electrochemical cells in which these electrode assemblies are used.

### CROSS-REFERENCE TO RELATED APPLICATIONS

This application claims priority to U.S. Provisional Patent Application 61/028,443, filed Feb. 13, 2008, which is incorporated by reference herein.

### BACKGROUND OF THE INVENTION

### Field of the Invention

The present invention relates generally to electrodes in electrochemical cells. More specifically, the invention provides for electrodes for use with solid polymer electrolytes.

The demand for rechargeable batteries has grown considerably as the global demand for technological products such as cellular phones, laptop computers and other consumer electronic products has escalated. In addition, interest in rechargeable batteries has been fueled by current efforts to develop green technologies such as electrical-grid load leveling devices and electrically-powered vehicles, which will create a very large market for rechargeable batteries with high energy densities.

Rechargeable Li-ion batteries are very popular for portable electronics. Li-ion batteries offer high energy and power densities, slow loss of charge when not in use, and they do not suffer from memory effects. Because their many benefits, including their high energy density, Li-ion batteries have also been used increasingly in defense, aerospace, back-up storage, and transportation applications.

Despite the push for better performance and lower cost in lithium ion batteries, there has been little change to the basic architecture of lithium ion cells, including the structure of cell electrodes. A standard porous electrode has active electrode material particles, electronically-conductive carbon particles, a fluorinated polymer binder to hold the particles together, and a network of open pores. Standard lithium ion cell electrodes are made porous so that a liquid electrolyte can fill the pores and make contact with the electrode active material. Such a structure by itself is fragile and, in most cases, is an insufficient conductor of electrons, so generally the electrode is deposited onto a metal current collector to form a complete electrode assembly.

Conventional metal current collectors serve three main purposes. They provide mechanical support to porous electrodes, which would fall apart otherwise. They prevent leakage of the liquid electrolyte through the porous electrode. And they provide a conductive path through which electrons can enter and leave the electrodes to deliver electricity to an outside circuit. The thickness of the current collectors is determined mainly by their mechanical function. Especially for low- to moderate-rate applications, current collectors are much thicker than is necessary to fulfill their electronic conduction function.

If electrodes could be designed to be freestanding and solid electrolytes were used, current collectors would be used only for their electronic conduction function. Electrodes could be made with smaller weight and volume and at lower cost.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic drawing of a conventional electrode for an electrochemical cell.

FIGS. 2A-2B are schematic drawings of a novel freestanding electrode according to an embodiment of the invention.

FIG. 3 is a schematic drawing of an electrochemical cell that has one novel electrode and one conventional electrode, according to an embodiment of the invention.

FIG. 4 is a schematic drawing of an electrochemical cell that has two novel electrodes, according to an embodiment of the invention.

FIG. 5 is a schematic drawing of a diblock copolymer and a domain structure it can form, according to an embodiment of the invention.

FIG. 6 is a schematic drawing of a triblock copolymer and a domain structure it can form, according to an embodiment of the invention.

FIG. 7 is a schematic drawing of a triblock copolymer and a domain structure it can form, according to another embodiment of the invention.

### DETAILED DESCRIPTION

The preferred embodiments are illustrated in the context of electrodes in electrochemical cells. More specifically, embodiments of the invention describe electrodes for use with a solid polymer electrolyte system. The electrodes have little or no inactive weight and can use a much thinner current collector than has been possible heretofore.

The term “freestanding” is used herein to mean being able to exist independently without being attached to any support. Some electrode films describe herein are freestanding. That is to say that the films have enough mechanical integrity on their own that they can be handled and processed without having to rely on an attached substrate for support. Of course, as used in a battery cell, electrode films are in communication with or attached to other cell components in order to carry out their electrochemical functions.

For the purpose of this disclosure, “reticulated” layer or film is used to mean a layer or film that includes discontinuities or open spaces yet still forms a connected network for the purposes of electron conduction. Examples include, but are not limited to nets, meshes, screens, perforated films or plates, and foams.

There have been previous attempts to reduce the thickness and weight of current collector layers in order to maximize volumetric and gravimetric energy and power in electrochemical cells. All such attempts have been made with electrode films that rely upon current collectors for mechanical support. In every case, the current collector has been prepared as a discreet film that is sturdy enough to support the electrode film during processing and throughout the lifetime of the cell in which it is used. Metalized polymer current collectors, as thin as 1-2 microns have been used to reduce the amount of metal used in the electrode assembly. The utility of such a material, however, depends on the strength, the ease of production, and, ultimately, the cost of the thin, insulating, inactive polymer substrate.

In the embodiments of the invention described herein the structural roles of the electrode film and the current collector can be reversed. A solid polymer electrolyte with sufficient mechanical strength serves not only to transport ionic current through the cell but also to bind together the active material particles and electronically-conducting particles in the electrode film, thus making a freestanding electrode film. Now the electrode film can be the substrate to which the current collector is attached to make an integrated electrode-current collector assembly. Very thin (e.g., 0.5-2 microns) current conductor layers can be adhered to one surface of the electrode layer in order to facilitate electron conduction between a battery terminal and an active electrode material, eliminating the need for a heavier and bulkier traditional current collector.

In addition, a thin battery designed for high specific energy and power, in which the cathode, anode, and separator are each less than 20 microns thick, is now possible. Such a battery cell configuration has reduced ohmic resistance during operation because of the smaller distances over with charge carriers travel. A traditional current collector (e.g., 10-20 microns) would constitute an unacceptably large weight fraction of the total cell, thus reducing the specific energy and power. Although solid polymer electrolytes may have lower conductivity than many of their liquid counterparts, their use in such a thin polymer-electrolyte cell with very thin current collectors may yet result in improved rate performance with comparable or improved specific energy and energy density.

Traditionally, a current collector serves three essential functions. It provides a low-resistance pathway through which electric current can enter or leave an electrode film. In the case of cells with porous electrodes for use with liquid electrolytes, the current collector also provides mechanical support to the electrode film and seals the electrode film to prevent leakage of the liquid electrolyte. Such traditional electrode films include a porous network of electrode active material particles and electronically conductive particles held together by an electrochemically inert whose sole purpose is to hold the inert whose sole purpose is to hold the electrode active particles and electronically-conductive particles together. A liquid electrolyte fills up voids in the porous network, serving as an ionic conductor to transport positive charges between electrodes and thus to form a functional cell. Such electrode films cannot stand alone and rely on their attachment to a current collector, e.g., an aluminum or copper foil between about 10 and 20 microns thick, to provide support and to hold the liquid electrolyte within the electrode assembly. In this configuration, the current collector constitutes a significant fraction of the total electrode assembly weight and volume (typically between about 5% and 25% for an electrochemical cell in which such an electrode assembly is used).

When a freestanding or self-supporting electrode film is used, a current collector is not needed for structural support, but only for its electronically conductive properties. The current collector thickness can be reduced considerably without creating excessive sheet resistance or loss of power. Such an ultra-thin current collector can confer significant weight and volume savings to the electrode assembly and thus to any cell in which the electrode assembly is used. In one embodiment of the invention, an electrode film is formed without a supportive substrate. For example, a low porosity electrode film with between about 10 and 50 weight % solid polymer electrolyte has sufficient mechanical strength to form a freestanding film. In one arrangement, such an electrode active film has a porosity less than about 30 weight %. In another arrangement, such an electrode active film has a porosity less than about 15 weight %. In another arrangement, such an electrode active film has a porosity less than about 5%. A very thin conductive film can be obtained by any of several methods. In one arrangement, a conductive film is deposited to one surface of a freestanding electrode film under vacuum using any of a variety of methods (e.g., evaporation, sputtering) as are known in the art. In another arrangement, a conductive material is cast onto one side of a freestanding electrode film. In yet another arrangement, a conductive film is formed by electroplating a metal from solution onto one face of a freestanding electrode film. In one arrangement, the current collector has a thickness less than about 10 μm. In another arrangement, the current collector has a thickness less than about 5 μm. In another arrangement, the current collector has a thickness less than about 2 μm. In another arrangement, the current collector has a thickness less than about 1 μm. In another arrangement, the current collector has a thickness of about 0.5 μm.

In order to maximize the specific energy and specific power (also energy density and power density) of an electrochemical cell, it is useful to minimize the weight and volume of the cell's passive components. The embodiments as disclosed herein provide an electrode assembly wherein the weight and volume of the current collector is reduced without sacrificing rate performance or mechanical integrity, resulting in significant gravimetric and volumetric energy and power density gains. Such an electrode assembly is especially useful for solid polymer electrolyte batteries in which reduced ionic conductivity makes thin cells a necessity for mid-to-high power applications. In such batteries there is an increased desire to reduce the weight and volume of the current collector in proportion to the thinner electrode films.

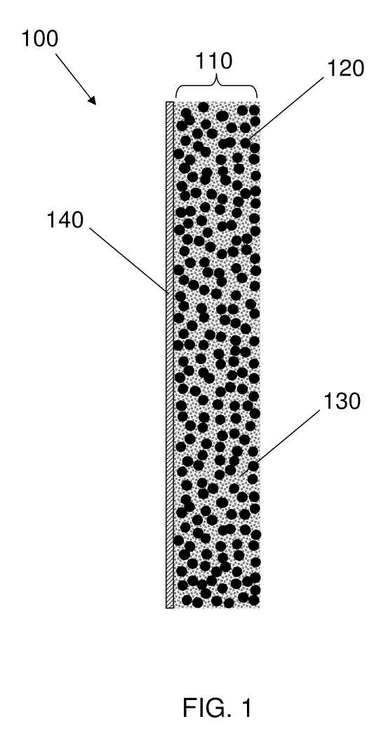

FIG. 1 is a cross-sectional schematic drawing of an electrode assembly 100 that includes an electrode film 110 and a current collector 140, according to an embodiment of the invention. The electrode film 110 has electrode active material particles 120 embedded in a matrix of solid polymer electrolyte 130 that also contains small, electronically-conductive particles (as indicated by small grey dots) such as carbon black. The solid polymer electrolyte 130 can be a polymer, a copolymer, or a blend thereof. In one arrangement, the solid polymer electrolyte 130 is a block copolymer electrolyte. In one arrangement, no additional binder material is added; the electrolyte 130 binds together the electrode active particles and the electronically-conductive particles and provides sufficient mechanical integrity to make the electrode film 110 freestanding. The block copolymer electrolyte 130 includes an ionically-conductive phase and a structural phase so that overall the block copolymer electrolyte has a modulus greater than about 1×10⁵ Pa at 25° C. In some arrangements, the block copolymer electrolyte 130 has a modulus greater than about 1×10⁶ Pa at 25° C. In some arrangements, the block copolymer electrolyte 130 has a modulus greater than about 1×10⁷ Pa at 25° C. In another arrangement, the electrode film 110 contains a small amount of an additional binder material, such as poly(vinylidene fluoride) or other fluorinated polymers to ensure that the film 110 is freestanding.

When a solid polymer electrolyte 130 is used, the electrolyte 130 cannot leak out of the electrode film 110, and there is no need for the current collector 140 to act as a barrier to hold liquid electrolyte within the electrode film 110. In some embodiments of the invention, the electrode film 110 has sufficient mechanical integrity to be freestanding. This makes it possible to use a very thin or reticulated metal current collectors whose only function is electronic conduction, thus reducing unnecessary weight and volume in the electrode assembly 100. Exemplary current collectors include aluminum and copper.

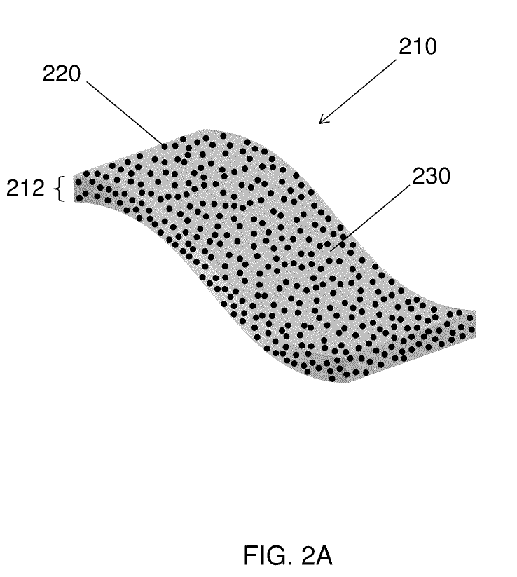

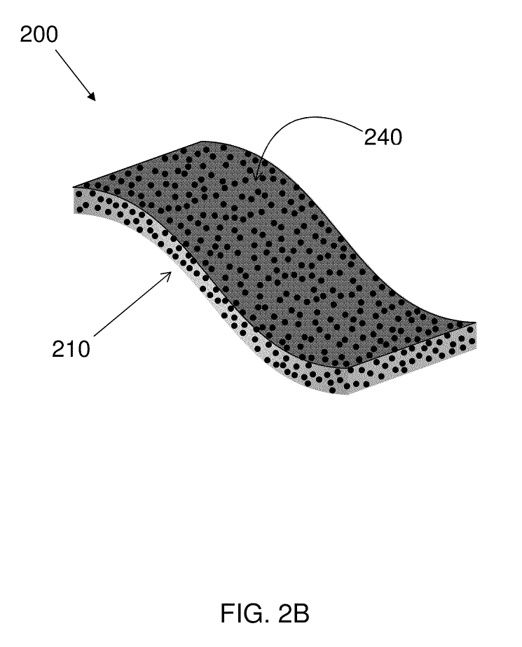

FIG. 2A is a schematic drawing of a freestanding electrode film 210, according to an embodiment of the invention. The electrode film 210 has electrode active material particles 220 embedded in a matrix of solid polymer electrolyte 230 that also contains small, electronically-conductive particles (not shown) such as carbon black. The solid polymer electrolyte 230 can be a polymer, a copolymer, or a blend thereof. In one arrangement, the solid polymer electrolyte 230 is a block copolymer electrolyte. In one arrangement, no additional binder material is used, and the electrode film 110 is freestanding. The block copolymer electrolyte 230 includes a structural phase so that overall the electrolyte has a modulus greater than about 1×10⁵ Pa at 25° C. In some arrangements, the block copolymer electrolyte 130 has a modulus greater than about 1×10⁶ Pa at 25° C. In some arrangements, the block copolymer electrolyte has a modulus greater than about 1×10⁷ Pa at 25° C. The electrode film 210 is flexible and can be formed into a wide variety of shapes as may be desired for individual applications. In one arrangement, the electrode film thickness 212 is between about 15 and 100 μm. In another arrangement, the electrode film thickness 212 is between about 15 and 50 μm.

FIG. 2B shows an electrode assembly 200 that includes the freestanding electrode film 210 of FIG. 2A and a thin current collector film 240. The thickness of the current collector 240 is just enough to provide a low-resistance pathway through which electric current can enter or leave the electrode film 210. In other arrangements (not shown), the current collector can be a reticulated metal layer or film. Examples of such layers include grid and mesh arrangements.

In one embodiment of the invention, the novel electrode is a positive electrode and contains positive electrode active material particles. The positive electrode active material can be any of a variety of materials depending on the type of electrochemical cell for which the electrode assembly is designed. In one embodiment of the invention, the cell is a lithium or lithium ion cell. The positive electrode active material can be any material that can serve as a host material for lithium ions. Examples of such materials include, but are not limited to materials described by the general formula LiₓA_{1-y}M_{y}O₂, wherein A comprises at least one transition metal selected from the group consisting of Mn, Co, and Ni; M comprises at least one element selected from the group consisting of B, Mg, Ca, Sr, Ba, Ti, V, Cr, Mn, Fe, Co, Ni, Cu, Al, In, Nb, Mo, W, 6, and Rh; x is described by 0.05≦x≦1.1; and y is described by 0≦y≦0.5. In one arrangement, the positive electrode material is LiNi_{0.5}Mn_{0.5}O₂.

In one arrangement, the positive electrode active material is described by the general formula: LiₓA_{2-y}M_{y}O₂, where M is chosen from Mn, Ni, Co, and/or Cr; x is described by 0.05≦x≦1.1; and y is described by 0≦y≦2. In another arrangement, the positive electrode active material is described by the general formula: LiₓM_{y}Mn_{4-y}O₈, where M is chosen from Fe and/or Co; x is described by 0.05≦x≦2; and y is described by 0≦y≦4. In another arrangement, the positive electrode active material is given by the general formula Liₓ(Fe_{y}M_{1-y})PO₄, where M is chosen from transition metals such as Mn, Co and/or Ni; x is described by 0.9≦x≦1.1; and y is described by 0≦y≦1. In yet another arrangement, the positive electrode active material is given by the general formula: Li(Ni_{0.5-x}Co_{0.5-x}M₂ₓ)O₂, where M is chosen from Al, Mg, Mn, and/or Ti; and x is described by 0≦x≦0.2. In some arrangements, the positive electrode material includes LiNiVO₂.

In one embodiment of the invention, the novel electrode is a negative electrode and contains negative electrode active material particles. The negative electrode active material can be any of a variety of materials depending on the type of electrochemical cell for which the electrode assembly is designed. In one embodiment of the invention, the cell is a lithium or lithium ion cell. The negative electrode material can be any material that can serve as a host material (i.e., can absorb and release) lithium ions. Examples of such materials include, but are not limited to graphite, lithium metal, and lithium alloys such as Li—Al, Li—Si, Li—Sn, and Li—Mg. Silicon and silicon alloys are known to be useful as negative electrode materials in lithium cells. Examples include silicon alloys of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) and mixtures thereof. In some arrangements, graphite, metal oxides, silicon oxides or silicon carbides can also be used as negative electrode materials.

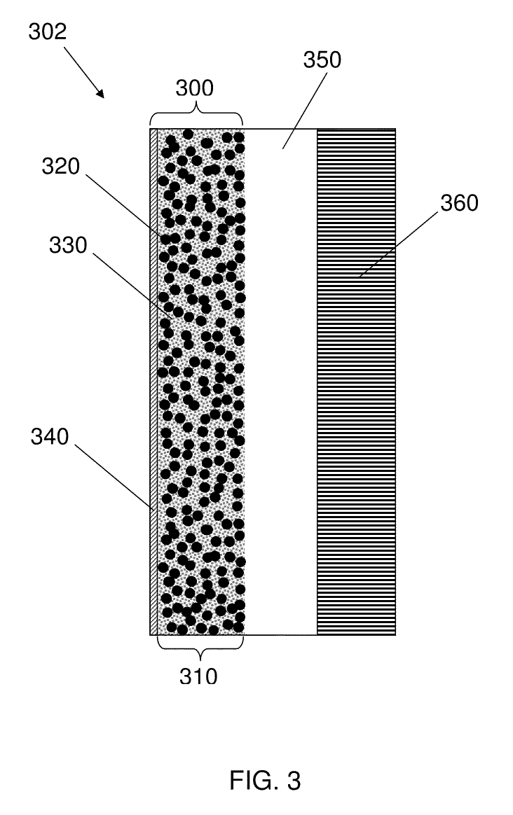

FIG. 3 is a cross-sectional schematic drawing of an electrochemical cell 302 with a positive electrode assembly 300 as described above FIG. 1, according to an embodiment of the invention. The positive electrode assembly 300 has a positive electrode film 310 and a current collector 340. The positive electrode film 310 has positive electrode active material particles 320 embedded in a matrix of solid electrolyte 330 that also contains small, electronically-conductive particles (as indicated by small grey dots) such as carbon black. The solid polymer electrolyte 330 can be a polymer, a copolymer, or a blend thereof. In one arrangement, the solid polymer electrolyte 330 is a block copolymer electrolyte. There is a positive electrode current collector 340 that may be a continuous or reticulated metal film as described above. There is a negative electrode 360 that is a metal layer, such as a lithium layer, that acts as both negative electrode active material and negative electrode current collector. In one arrangement (not shown), the negative electrode is a negative electrode assembly that includes a reticulated film of negative electrode material covered with a solid polymer electrolyte. The solid polymer electrolyte may or may not be the same as the solid polymer electrolyte 330 in the positive assembly 300. There is a separator region 350 filled with an electrolyte that provides ionic communication between the positive electrode film 310 and the negative electrode 360. In one arrangement, the separator region 350 contains a solid electrolyte and can be the same solid electrolyte (without the carbon particles) as is used in the positive electrode film 310 and/or in the negative electrode assembly.

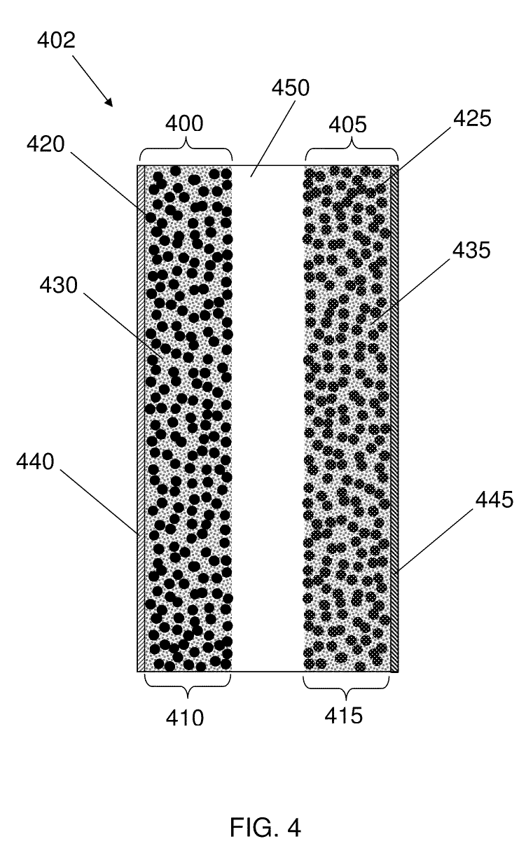

FIG. 4 is a cross-sectional schematic drawing of an electrochemical cell 402 with both a positive electrode assembly 400 and a negative electrode assembly 405 as described above FIG. 1, according to an embodiment of the invention. The positive electrode assembly 400 has a positive electrode film 410 and a current collector 440. The positive electrode film 410 has positive electrode active material particles 420 embedded in a matrix of solid polymer electrolyte 430 that also contains small, electronically-conductive particles (as indicated by small grey dots) such as carbon black. The solid polymer electrolyte 430 can be a polymer, a copolymer, or a blend thereof. In one arrangement, the solid polymer electrolyte 430 is a block copolymer electrolyte. There is a positive electrode current collector 440 that may be a continuous or reticulated metal film as described above. The negative electrode assembly 405 has a negative electrode film 415 and a current collector 445. The negative electrode film 415 has negative electrode active material particles 425 embedded in a matrix of solid polymer electrolyte 435 that also contains small, electronically-conductive particles (as indicated by small grey dots) such as carbon black. The solid polymer electrolyte 435 can be a polymer, a copolymer, or a blend thereof. In one arrangement, the solid polymer electrolyte 435 is a block copolymer electrolyte. The electrolytes 430, 435 may or may not be the same. There is a negative electrode current collector 445 that may be a continuous or reticulated metal film as described above. There is a separator region 450 filled with an electrolyte that provides ionic communication between the positive electrode film 410 and the negative electrode film 415. In one arrangement, the separator region 450 contains a solid electrolyte and can be the same solid electrolyte (without the carbon particles) as is used in the positive electrode film 410 and/or in the negative electrode film 315.

### Solid Polymer Electrolytes

As described in detail above, a solid polymer electrolyte, such as a block copolymer electrolyte can be used in the embodiments of the invention.

In one embodiment of the invention, the solid polymer electrolyte (e.g., the block copolymer electrolyte) has an ionic conductivity of at least 1×10⁻⁵ S cm⁻¹ at 25° C. In another embodiment of the invention, the solid polymer electrolyte (e.g., the block copolymer electrolyte) has an ionic conductivity of at least 1×10⁻⁴ S cm⁻¹ at 25° C. In one embodiment of the invention, the solid polymer electrolyte (e.g., the block copolymer electrolyte) has a modulus greater than 1×10⁵ Pa at 25° C. In some arrangements, the block copolymer electrolyte 130 has a modulus greater than about 1×10⁶ Pa at 25° C. In some arrangements, the block copolymer electrolyte 130 has a modulus greater than about 1×10⁷ Pa at 25° C.

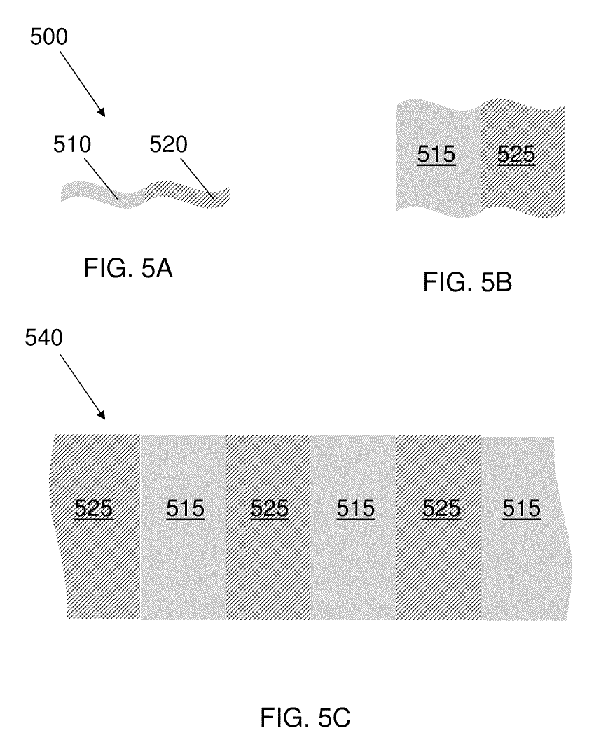

FIG. 5A is a simplified illustration of an exemplary diblock polymer molecule 500 that has a first polymer block 510 and a second polymer block 520 covalently bonded together. In one arrangement both the first polymer block 510 and the second polymer block 520 are linear polymer blocks. In another arrangement, either one or both polymer blocks 510, 520 has a comb structure. In one arrangement, neither polymer block is cross-linked. In another arrangement, one polymer block is cross-linked. In yet another arrangement, both polymer blocks are cross-linked.

Multiple diblock polymer molecules 500 can arrange themselves to form a first domain 515 of a first phase made of the first polymer blocks 510 and a second domain 525 of a second phase made of the second polymer blocks 520, as shown in FIG. 5B. Diblock polymer molecules 500 can arrange themselves to form multiple repeat domains, thereby forming a continuous nanostructured block copolymer material 540, as shown in FIG. 5C. The sizes or widths of the domains can be adjusted by adjusting the molecular weights of each of the polymer blocks.

In one arrangement the first polymer domain 515 is ionically conductive, and the second polymer domain 525 provides mechanical strength to the nanostructured block copolymer.

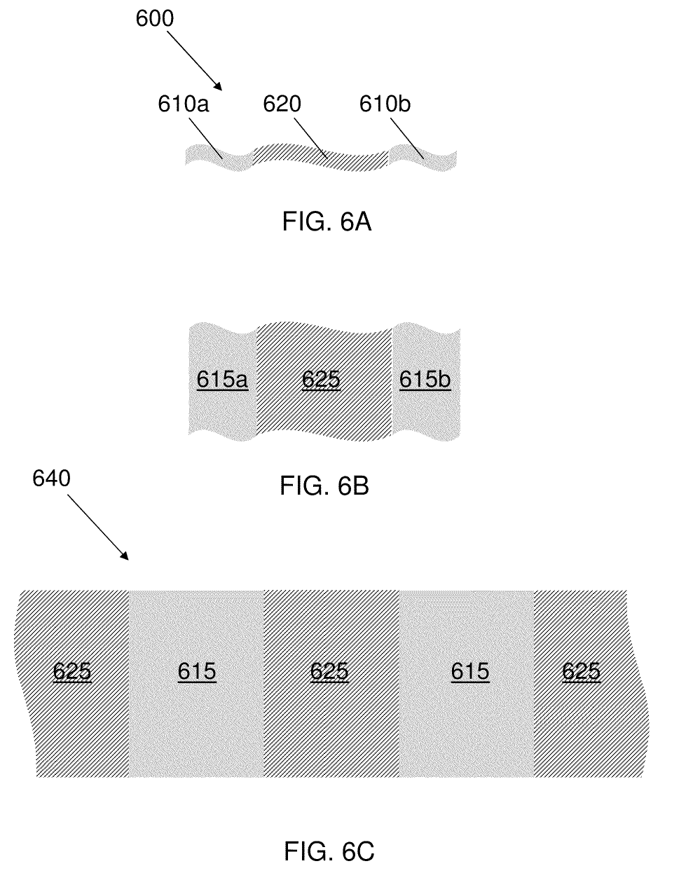

FIG. 6A is a simplified illustration of an exemplary triblock polymer molecule 600 that has a first polymer block 610a, a second polymer block 620, and a third polymer block 610b that is the same as the first polymer block 610a, all covalently bonded together. In one arrangement the first polymer block 610a, the second polymer block 620, and the third copolymer block 610b are linear polymer blocks. In another arrangement, either some or all polymer blocks 610a, 620, 610b have a comb structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 600 can arrange themselves to form a first domain 615 of a first phase made of the first polymer blocks 610a, a second domain 625 of a second phase made of the second polymer blocks 620, and a third domain 615b of a first phase made of the third polymer blocks 610b as shown in FIG. 6B. Triblock polymer molecules 600 can arrange themselves to form multiple repeat domains 625, 615 (containing both 615a and 615b), thereby forming a continuous nanostructured block copolymer 630, as shown in FIG. 6C. The sizes of the domains can be adjusted by adjusting the molecular weights of each of the polymer blocks.

In one arrangement the first and third polymer domains 615a, 615b are ionically conductive, and the second polymer domain 625 provides mechanical strength to the nanostructured block copolymer. In another arrangement, the second polymer domain 625 is ionically conductive, and the first and third polymer domains 615 provide a structural framework.

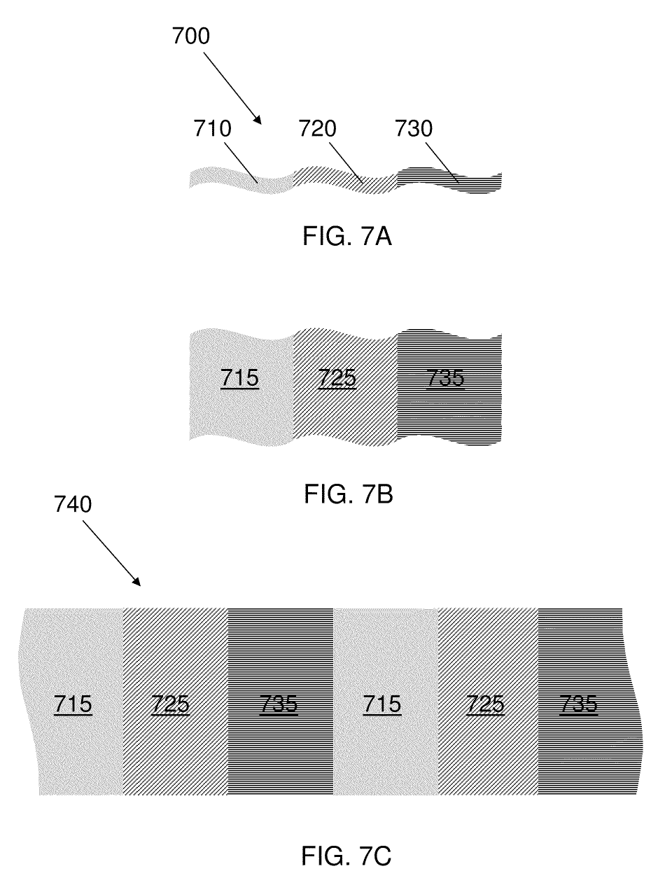

FIG. 7A is a simplified illustration of another exemplary triblock polymer molecule 700 that has a first polymer block 710, a second polymer block 720, and a third polymer block 730, different from either of the other two polymer blocks, all covalently bonded together. In one arrangement the first polymer block 710, the second polymer block 720, and the third copolymer block 730 are linear polymer blocks. In another arrangement, either some or all polymer blocks 710, 720, 730 have a comb structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 700 can arrange themselves to form a first domain 715 of a first phase made of the first polymer blocks 710a, a second domain 725 of a second phase made of the second polymer blocks 720, and a third domain 735 of a third phase made of the third polymer blocks 730 as shown in FIG. 7B. Triblock polymer molecules 700 can arrange themselves to form multiple repeat domains, thereby forming a continuous nanostructured block copolymer 740, as shown in FIG. 7C. The sizes of the domains can be adjusted by adjusting the molecular weights of each of the polymer blocks.

In one arrangement the first polymer domains 715 are ionically conductive, and the second polymer domains 725 provide mechanical strength to the nanostructured block copolymer. The third polymer domains 735 provides an additional functionality that may improve mechanical strength, ionic conductivity, chemical or electrochemical stability, may make the material easier to process, or may provide some other desirable property to the block copolymer. In other arrangements, the individual domains can exchange roles.

Choosing appropriate polymers for the block copolymers described above is important in order to achieve desired electrolyte properties. In one embodiment, the conductive polymer (1) exhibits ionic conductivity of at least 10⁻⁵ Scm⁻¹ 1 at electrochemical cell operating temperatures (e.g., 25° C.) when combined with an appropriate salt(s), such as lithium salt(s); (2) is chemically stable against such salt(s); and (3) is thermally stable at electrochemical cell operating temperatures. In one embodiment, the structural material has a modulus in excess of 1×10⁵ Pa at electrochemical cell operating temperatures. In one embodiment, the third polymer (1) is rubbery; and (2) has a glass transition temperature lower than operating and processing temperatures. It is useful if all materials are mutually immiscible.

In one embodiment of the invention, the conductive phase can be made of a linear polymer. Conductive linear polymers that can be used in the conductive phase include, but are not limited to, polyethers, polyamines, polyimides, polyamides, alkyl carbonates, polynitriles, and combinations thereof. The conductive linear polymers can also be used in combination with polysiloxanes, polyphosphazines, polyolefins, and/or polydienes to form the conductive phase.

In another exemplary embodiment, the conductive phase is made of comb polymers that have a backbone and pendant groups. Backbones that can be used in these polymers include, but are not limited to, polysiloxanes, polyphosphazines, polyethers, polydienes, polyolefins, polyacrylates, polymethacrylates, and combinations thereof. Pendants that can be used include, but are not limited to, oligoethers, substituted oligoethers, ethylene carbonate, nitrile groups, sulfones, alkylene oxides, substituted alkylene oxides, oligoethers, thiols, polyethers, polyamines, polyimides, polyamides, alkyl carbonates, polynitriles, other polar groups, and combinations thereof.

Further details about polymers that can be used in the conductive phase can be found in U.S. Provisional Patent Application No. 61/056,688, filed May 28, 2008, U.S. Provisional Patent Application No. 61/091,626, filed Aug. 25, 2008, U.S. Provisional Patent Application No. 61/145,518 filed Jan. 16, 2009, U.S. Provisional Patent Application No. 61/145,507, filed Jan. 16, 2009, all of which are included by reference herein.

There are no particular restrictions on the electrolyte salt that can be used in the block copolymer electrolytes. Any electrolyte salt that includes the ion identified as the most desirable charge carrier for the application can be used. It is especially useful to use electrolyte salts that have a large dissociation constant within the polymer electrolyte.

Suitable examples include alkali metal salts, such as Li salts. Examples of useful Li salts include, but are not limited to, LiPF₆, LiN(CF₃SO₂)₂, Li(CF₃SO₂)₃C, LiN(SO₂CF₂CF₃)₂, LiB(C₂O₄)₂, B₁₂FₓH₁₂₋ₓ, solid polymer electrolyte be added to nanostructured block copolymer electrolytes to enhance the ionic conductivity, to enhance the mechanical properties, or to enhance any other properties that may be desirable.

The ionic conductivity of nanostructured block copolymer electrolyte materials can be improved by including one or more additives in the ionically conductive phase. An additive can improve ionic conductivity by lowering the degree of crystallinity, lowering the melting temperature, lowering the glass transition temperature, increasing chain mobility, or any combination of these. A high dielectric additive can aid dissociation of the salt, increasing the number of Li+ ions available for ion transport, and reducing the bulky Li+[salt] complexes. Additives that weaken the interaction between Li+ and PEO chains/anions, thereby making it easier for Li+ ions to diffuse, may be included in the conductive phase. The additives that enhance ionic conductivity can be broadly classified in the following categories: low molecular weight conductive polymers, ceramic particles, room temp ionic liquids (RTILs), high dielectric organic plasticizers, and Lewis acids.

Other additives can be used in the polymer electrolytes described herein. For example, additives that help with overcharge protection, provide stable SEI (solid electrolyte interface) layers, and/or improve electrochemical stability can be used. Such additives are well known to people with ordinary skill in the art. Additives that make the polymers easier to process, such as plasticizers, can also be used.

Further details about block copolymer electrolytes are described in U.S. patent application Ser. No. 12/225,934, filed Oct. 1, 2008, U.S. patent application Ser. No. 12/271,1828, filed Nov. 14, 2008, and PCT Patent Application Number PCT/US09/31356, filed Jan. 16, 2009, all of which are included by reference herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

1. An electrode assembly, comprising:
a freestanding film comprising electrode active particles and a solid polymer electrolyte;
wherein the solid polymer electrolyte acts as both a both binder and an electrolyte.

2. The electrode assembly of claim 1 further comprising electronically conducting particles in the freestanding film.

3. The electrode assembly of claim 1 wherein the freestanding film includes no additional binder material.

4. The electrode assembly of claim 1 wherein the electrode is a cathode, and the active particle material is described by the general formula LiₓA_{1-y}M_{y}O₂, wherein A comprises at least one transition metal selected from the group consisting of Mn, Co, and Ni; M comprises at least one element selected from the group consisting of B, Mg, Ca, Sr, Ba, Ti, V, Cr, Mn, Fe, Co, Ni, Cu, Al, In, Nb, Mo, W, and Rh; x is described by 0.05≦x≦1.1; and y is described by 0≦y≦0.5.

5. The electrode assembly of claim 4 wherein the electrode is a cathode and the active particle material is LiNi_{0.5}Mn_{0.5}O₂.

6. The electrode assembly of claim 1 wherein the electrode is an anode, and the active particles are selected from the group consisting of graphite, metal, lithium metal, lithium alloys, silicon, silicon alloys, metal oxides, silicon oxides, silicon carbides, combinations thereof.

7. The electrode assembly of claim 1 wherein the solid polymer electrolyte is a block copolymer comprising a structural block and an ionically-conducting block.

8. The electrode assembly of claim 7 wherein the structural block comprises one or more materials selected from the group consisting of polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, copolymers that contain styrene, methacrylate, or vinylpyridine, and combinations thereof.

9. The electrode assembly of claim 7 wherein the ionically-conducting block comprises one or more materials selected from the group consisting of polyethers, polyamines, polyimides, polyamides, alkyl carbonates, polynitriles, and combinations thereof.

10. The electrode assembly of claim 7 wherein the ionically-conducting block comprises a comb polymer that has a backbone and pendant groups.

11. (canceled)

12. (canceled)

13. The electrode assembly of claim 7 wherein the ionically-conducting block further comprises a conductivity-enhancing species.

14. (canceled)

15. The electrode assembly of claim 1 further comprising a metal current collector adjacent one side of the freestanding film.

16. The electrode assembly of claim 15, wherein the current collector has a thickness less than about 20 microns.

17. (canceled)

18. The electrode assembly of claim 15, wherein the current collector has a thickness less than about 5 microns.

19. (canceled)

20. (canceled)

21. (canceled)

22. The electrode assembly of claim 15 wherein the current collector comprises a grid, a mesh, or a reticulated film.

23. (canceled)

24. The electrode assembly of claim 1, wherein the electrode active film has a porosity less than about 15%.

25. (canceled)

26. (canceled)

27. (canceled)

28. (canceled)

29. (canceled)

30. A battery cell comprising
a positive electrode assembly comprising:
a freestanding film comprising positive electrode active particles,
electronically conductive particles, and a first solid polymer electrolyte; and
a metal current collector adjacent one side of the freestanding film;
wherein the first solid polymer electrolyte acts as both a binder and a first electrolyte.
a negative electrode comprising a lithium metal layer, and
a separator region comprising a second solid polymer electrolyte positioned between and in ionic communication with both the positive electrode assembly and the negative electrode assembly.

31. The battery cell of claim 30 wherein the freestanding film includes no additional binder material.

32. The battery cell of claim 30 wherein the negative electrode comprises a reticulated lithium metal layer covered with a solid polymer electrolyte.

33. The battery cell of claim 30 wherein either one or both of the first solid polymer electrolyte and the second solid polymer electrolyte comprise block copolymers that have both structural blocks and ionically-conducting blocks.

34. The battery cell of claim 30 wherein the first solid polymer electrolyte and the second solid polymer electrolyte are the same.

35. (canceled)

36. (canceled)

37. (canceled)

38. A battery cell comprising
a) a positive electrode assembly comprising:
a freestanding positive electrode film comprising positive electrode active particles, electronically conductive particles, and a first solid polymer electrolyte; and
a positive electrode current collector adjacent one side of the freestanding positive electrode film;
b) a negative electrode assembly comprising:
a freestanding negative electrode film comprising negative electrode active particles, electronically conductive particles, and a second solid polymer electrolyte; and
a negative electrode current collector adjacent one side of the freestanding negative electrode film; and
c) a separator region comprising a third solid polymer electrolyte positioned between and in ionic communication with both the positive electrode assembly and the negative electrode assembly.
wherein the first solid polymer electrolyte and the second solid polymer electrolyte act as both binders and electrolytes.

39. The battery cell of claim 38 wherein neither the freestanding positive electrode film nor the freestanding negative electrode film includes any additional binder material.

40. The battery cell of claim 38 wherein one or more of the first solid polymer electrolyte, the second solid polymer electrolyte, and the third solid polymer electrolyte comprise block copolymers that have both structural blocks and ionically-conducting blocks.

41. The battery cell of claim 40 wherein the first solid polymer electrolyte, the second solid polymer electrolyte, and the third solid polymer electrolyte are the same.

42. (canceled)

43. (canceled)

44. (canceled)
